(19) United States
(12) Patent Application Publication
(10) Pub. No.: US 2008/0066359 A1
(43) Pub. Date: Mar. 20, 2008

(54) Removable bill of lading label for security seal

(75) Inventors: Paul A. Littrell, Fort Wayne, IN (US); Wanda K. Beard, Angola, IN (US); David L. Gilbert, Fort Wayne, IN (US)

Correspondence Address: PILLSBURY WINTHROP SHAW PITTMAN, LLP, P.O. BOX 10500, MCLEAN, VA, 22102, US

(73) Assignee: Tyden Brammall Inc., Angola, IN (US)

(21) Appl. No.: 11/520,659

(22) Filed: Sep. 14, 2006

(51) Int. Cl. G09F 3/14

(52) U.S. Cl. 40/665

(57) ABSTRACT

A label and a label for a security seal are described. The label includes a flexible body with first and second portions connected to one another via a separable connection. A first adhesive is disposed on a rear surface of the first portion. A second adhesive is disposed on a rear surface of the second portion. First information is applied to the first portion. Second information is applied to the second portion. At least a portion of the first information is identical to a portion of the second information. Either the first portion or the second portion includes tamper-evident indicia such that attempted separation of either portion from a substrate, once affixed, exposes the tamper-evident indicia. The first adhesive is formulated to securely affix the first portion to a seal body. The second adhesive is formulated to securely affix the second portion to a document.

### CROSS-REFERENCE TO RELATED APPLICATION(S)

This application is a first-filed application and does not rely on any other application for priority.

### BACKGROUND OF THE INVENTION

1. Field of the Invention

The present invention relates to security devices. In particular, the invention relates to security seals for rail cars and tanker trucks

2. Description of Related Art

Security seals are used widely in the shipping industry to provide tamper-resistant closures for many different types of shipping containers and shipping receptacles, including tanker trucks, tanker cars, and rail cars, among others. In one common example, one or more security seals are placed on the exterior of a shipping container (e.g., a container that is placed on a cargo ship for domestic or international shipping) after the contents of the container are verified. In the shipping industry, security seals (or security devices) are also known as mechanical seals.

There are many reasons for which a shipper might want (or be required) to seal a container after identified contents are placed therein. For example, for international shipping, customs authorities may require that the freight container be sealed. In addition, in domestic shipping situations, there is often be a need to seal a freight container for purposes of preventing tampering with the contents of the freight container.

Regardless of the reasons for which a security seal is employed, the security seal is expected to perform its intended function—namely to discourage opening of the container and/or to indicate if the container has been opened during transit for any reason. If the seal is broken, the recipient of the container may be able to quickly and easily determine that the container has been opened so that the recipient may reject the shipment, take appropriate corrective action, etc.

Many types of security seals are used in the shipping industries. Examples of these are bolt seals, cable seals, and plastic seals, among others. Currently, many of the bolt seals, cable seals, and plastic seals have identification codes imprinted on a surface of the security seal.

Typically, when shipping containers are prepared for dispatch, after the container, tanker truck, rail car, etc. is sealed, identification information is copied from the security seal onto a bill of lading. The identification information, which is usually a serial number, may be relied upon by the shipper, various cargo handlers at one or more waylay points during shipping, and the recipient to verify that the container has remained in an unopened state during transit.

At the point of shipment, it is important for the identification information to be copied correctly onto the bill of lading. When the identification information is copied incorrectly, issues arise when reconciling the shipping records. As would be appreciated by those skilled in the art, this may present difficulties. For example, if the wrong serial number is transcribed onto the bill of lading, the shipment recipient may refuse acceptance of the shipment, even though the error was purely clerical in nature.

There have been solutions to problems similar to this that have been proposed in the prior art. For example, to avoid transcription errors, shippers have employed two-part labels, where appropriate. As would be understood by those skilled in the art, the shipper may retain one portion of the two-part label, the other portion being provided for various purposes.

In one conventional example, as described in U.S. Pat. No. 927,710, a two-part claim tag is described, which is proposed for use in a typical bailment situation. As described in that patent, one part of the claim tag is affixed to the item being shipped, such as an automobile. The detachable portion of the claim tag is presented to the owner of the item so that that owner may claim his or her vehicle at the conclusion of the journey (the point of receipt). In this example, each portion of the two-part claim tag is inscribed with the same claim number.

This claim tag system is still widely used today in bailment situations as described in U.S. Pat. No. 6,898,880. In addition, as would be appreciated by those skilled in the art, in urban settings, when it is necessary to park an automobile in a garage, it is not uncommon for an attendant to place one part of a two-part claim tag under the windshield wiper of the vehicle. The detached portion of the claim tag is retained by the vehicle owner until the vehicle owner returns to retrieve the vehicle from the parking attendant. The two parts of the claim tag are pre-printed with the same claim number.

Two-part identifying tags are also known for use in other industries. One example is provided by U.S. Pat. No. 3,593,443. Here, a two-part document is presented for use in clinical trials for medicaments. One portion of the identifying document is designed to be placed in the patient's file while the other portion is affixed, with a suitable adhesive, to the container in which the medicaments are placed. The portion of the document affixed to the medicaments contains the necessary patient and study information. The remaining portion of the document, which is retained in the patient's file, contains the nature of the medicament and the dosage.

Additionally, as would be appreciated by those skilled in the art, security seals with removable identification portions are used in many applications. One example is described in U.S. Pat. No. 6,343,819. Here a security tag is described that may be attached to luggage or items vulnerable to theft. The security tag has a strap that is wrapped around and locked into a socket. The flat body of the security tag has two portions with pre-printed information. One part of the identification is removable and can be retained to be compared to the security tag, at a later point (e.g., upon retrieval of the luggage), to establish ownership of the item.

Another example is shown in U.S. Pat. No. 5,337,503. Here, a flexible band security seal made of wound metal wire includes a detachable member with a code printed on it. The seal includes an identical code printed on it. The detachable member with the code is removed prior to affixing the security seal to the item it is securing. The detachable member may be attached to a document, for example.

Another example of a security deal with a removable portion is described in U.S. Pat. No. 5,765,885. Here, the security seal has a free end that is looped around and threaded through a tunnel, with locking teeth, to secure the free end to the tunnel. The free end can be pulled through the tunnel to make the loop smaller. In the described example, the security seal includes two flat plates, one that is incorporated into the security seal. The other plate is retained by the sender.

Another issue that arises in connection with the use of security seals is security, as the name suggests. Specifically, it is useful, in certain circumstances, for the security seal to incorporate features that indicate if a person has tampered with a security seal. If tampering is evident, the recipient of the shipment may elect to reject the shipment or to process the shipment according to internal policies appropriate for the given circumstances.

One example is shown in U.S. Pat. No. 5,219,194. Here, the security seal has an adhesive layer applied to the seal with information printed on both the adhesive and the seal. The information from the seal appears through the adhesive layer. When the adhesive layer is removed, such as when a person attempts to tamper with the seal, a visual indication of tampering, such as the word “VOID,” appears.

In addition, single labels with adhesive backings have been attached to security seals to allow information to be transferred to documents such as the bill of lading.

While the prior art offers many examples of security seals and bailment documents, a need exists in the art for a security seal that both permits identification information to be transferred easily and reliably to a suitable document, such as a bill of lading, and that also provides features to indicate tampering with the security seal. Still other needs exist, as would be appreciated by those skilled in the art.

### SUMMARY OF THE INVENTION

It is one aspect, therefore, of the present invention to provide a security seal that permits identification information to be transferred easily and reliably to a suitable document, such as a bill of lading.

It is another aspect of the present invention to provide a security seal that provides indicia of tampering.

### BRIEF DESCRIPTION OF THE DRAWINGS

The drawings appended hereto illustrate various aspects and features of the present invention, in which:

FIG. 1 illustrates a label with a first and a second portion attached to each other via a suitable separable connection;

FIG. 2 illustrates the label shown in FIG. 1, with a corner of one portion of the label being folded over to indicate the presence of a suitable adhesive applied to the back thereof;

FIG. 3 illustrates the label depicted in FIG. 1, after the first and second portions have been separated along the separable connection in the label;

FIG. 4 illustrates one embodiment of a bolt security seal, otherwise known as a bolt seal;

FIG. 5 illustrates on example of the label, depicted in FIG. 1, after it has been affixed to the bolt seal shown in FIG. 4;

FIG. 6 illustrates one example of a cable security seal, also referred to as a cable seal;

FIG. 7 illustrates the label, shown in FIG. 1, after being affixed to the cable seal depicted in FIG. 6;

FIG. 8 provides a top view of one example of a plastic security seal, also known as a plastic seal;

FIG. 9 provides a side view of the plastic seal illustrated in FIG. 8;

FIG. 10 illustrates the label, shown in FIG. 1, after being affixed to the plastic seal depicted in FIG. 8;

FIG. 11 illustrates the cable seal, shown in FIG. 7, with a removable portion of the label removed and affixed to a document, such as a bill of lading;

FIG. 12 illustrates the cable seal, depicted in FIG. 11, after the removable portion of the label has been removed;

FIG. 13 illustrates one embodiment of the tamper-evident properties of the first portion of the label when removal is completed or attempted; and

FIG. 14 illustrates another embodiment of the tamper-evident properties of the first portion of the label when removal is completed or attempted.

### DETAILED DESCRIPTION OF INVENTION EMBODIMENTS

Embodiments of the present invention will be described in detail with reference to the accompanied drawings. As would be appreciated by those skilled in the art, the embodiments are intended to illustrate the breadth and scope of the present invention. The present invention is not intended to be limited solely to the embodiments described and illustrated. Other embodiments may be contemplated by those skilled in the art, and those embodiments are intended to be encompassed by the scope of the claims appended hereto.

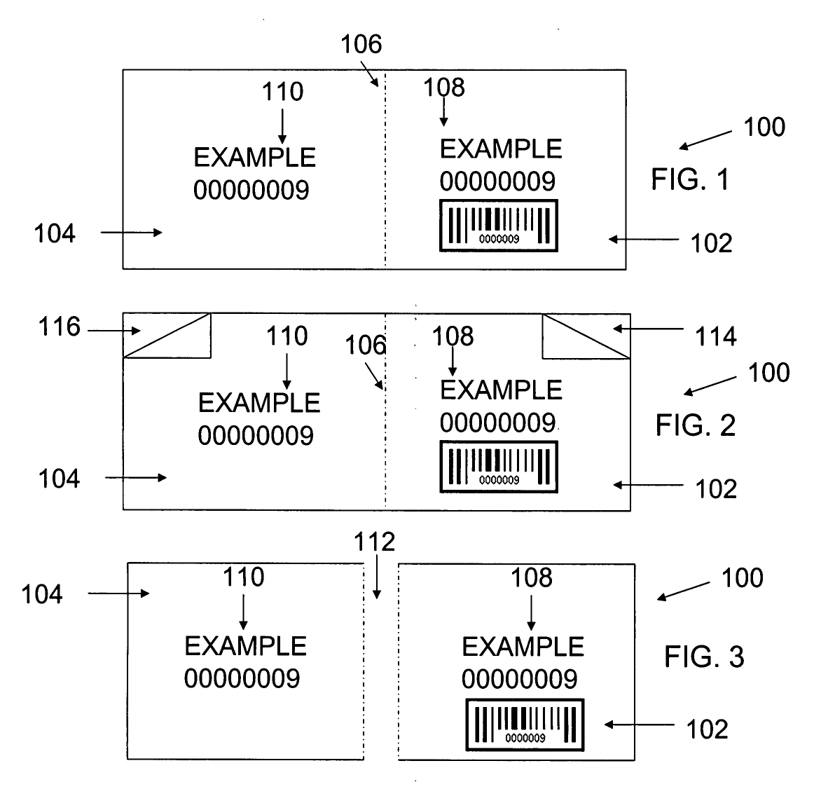

As illustrated in FIG. 1, a label 100 includes a first portion 102 attached to a second portion 104, by a separable connection, such as a perforation 106. Alternatively, the first portion 102 and second portion 104 of the label 100 may be separated from each other by another type of separable connection, such as a frangible break line 112. The frangible break line 112 may be a scoring of the surface or the underside of the label 100. As would be appreciated by those skilled in the art, other types of separable connections may be employed to facilitate separation of the first portion 102 of the label 100 from the second portion 104.

In the embodiment illustrated in FIGS. 1-3, the body of the label 100 is flexible. While the body of the label 100 may be made from any type of flexible material, embodiments of the label 100 include those made from cellulose or a paper material. In another embodiment, the flexible body of the label 100 may be made from an elastomeric material, including plastic. In still further embodiments, the label 100 may be constructed from a metal, an alloy, or foil, among other materials. As also would be appreciated by those skilled in the art, the label 100 may be constructed from a variety of materials in a layered fashion, among others.

It is also contemplated that the first portion 102 and the second portion 104 of the label 100 may be made from different materials. For example, the first portion 102 may be made from plastic while the second portion 104 is made from paper. As would be appreciated by those skilled in the art, other combinations are also possible.

In the illustrated embodiment, the label 100 is made from a flexible material to facilitate affixation of the second portion 104 of the label 100 to a suitable document. As would be appreciated by those skilled in the art, the label 100 need not be made from a flexible material. A rigid or semi-rigid material may also be used without departing from the scope of the present invention.

As illustrated in FIGS. 1-3, the first portion 102 of the label 100 contains first identification information 108 and the second portion 104 of the label 100 contains second identification information 110 on or in a front surface thereof. The first identification information 108 may be the same as the second identification information 110. Alternatively, the first identification information 108 may differ from the second identification information 110.

The identification information 108, 110 may be any type of readable information. Examples of the identification information 108, 110 include, but are not limited to, alphanumeric characters, barcodes, laser printed information, holographic information, pictorial information, graphical information, and/or magnetic information. As would be appreciated by those skilled in the art, the identification information 108, 110 may be applied to or incorporated into the first and second portions 102, 104 of the label 100 via any suitable construction.

With respect to the identification information 108, 110, it is contemplated that at least a portion of the first identification information 108 will be the same as the second identification information 110. In one example, the serial numbers on both portions 102, 104 of the label 100 will be the same. It is also contemplated that the two portions 102, 104 of the label 100 will contain different information, as may be required or desired for a particular application. It is contemplated that intentionally different information may provide enhanced security, for example.

As illustrated in FIG. 2, the first portion 102 of the label 100 includes a first adhesive 114 on a back surface. The second portion 110 of the label 100 includes a second adhesive 116 on a back surface.

In one contemplated embodiment, the first adhesive 114 for the first portion 102 of the label 100 differs from the second adhesive 116 applied to the second portion 104 of the label 100. Specifically, in this embodiment, the first portion 102 of the label 100 includes a first adhesive 114 that provides secure adhesion of the first portion 102 to the surface of a seal 400, 600, 800. The second adhesive 116 applied to the second portion 104 provides secure adhesion to a document 1100, such as a bill of lading.

In another contemplated embodiment, the first adhesive 114 applied to the first portion 102 of the label 100 is the same adhesive applied to the second portion 104 of the label 100. In this embodiment, since the same adhesive is applied to both portions 102, 104 of the label 100, manufacture of the label 100 is simplified.

The adhesive 114, 116 can be comprised of acrylic, polyethylene, polypropylene, polyester, polytetrafluoroethlyene, polyvinyl-chloride, and/or be a dry adhesive activated by heat, among other types of adhesives. The adhesive 114, 116 can also be solvent based, rubber based, or resistant to ultraviolet light, for example. The adhesive 114, 116 can be different thicknesses and have different levels of adhesion. The adhesive 114, 116 may be any other type of adhesive compatible with the surface to which it is being applied.

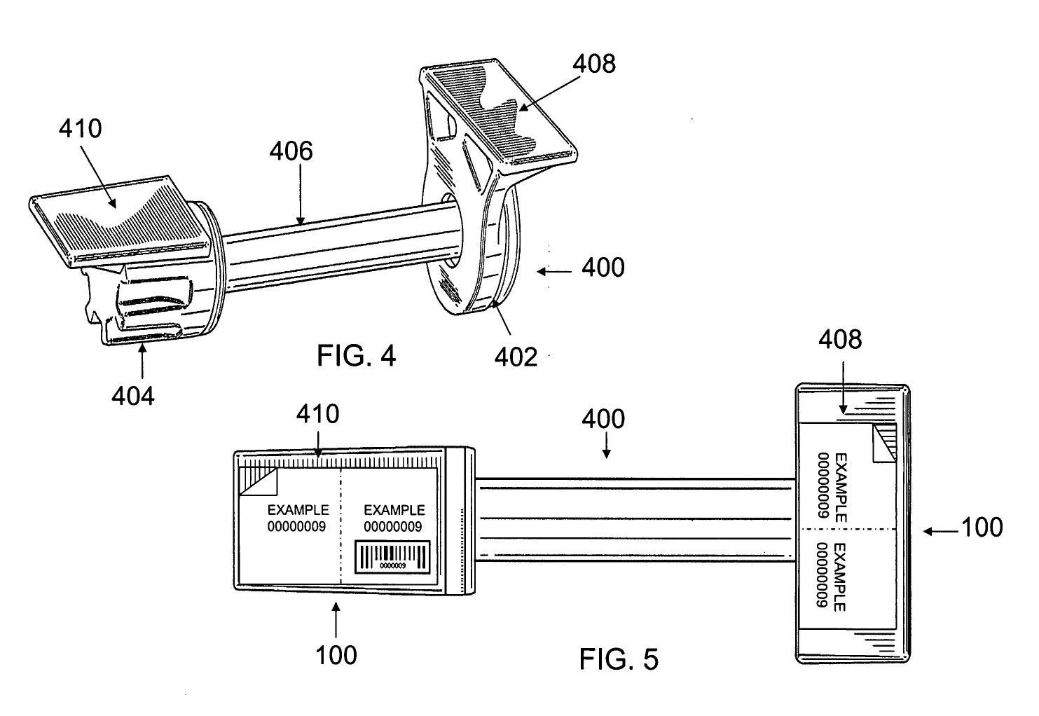

FIG. 4 illustrates a bolt seal 400 for securing a shipping container, tanker truck, rail car, or other freight vehicle. The bolt seal 400 includes a first end cap 402 and a second end cap 404. A bolt 406 extends between the first end cap 402 and the second end cap 404. In a typical example, the first end cap 402 is secured to one end of the bolt 406. The second end cap 404 is a separate element from the bolt seal 400 and is attached to the bolt 406 after the bolt 406 has been inserted through the locking structures (not shown) on the doors, for example, of the freight container. The first end cap 402 may be provided with a flat surface 408 onto which the label 100 may be affixed. Similarly, the second end cap 404 may be provided with a flat surface 410 onto which the label 100 may be affixed.

FIG. 5 illustrates the label 100 affixed to both the first end cap 402 and the second end cap 404. In one contemplated embodiment, the label 100 may be affixed to both end caps 402, 404. In another contemplated embodiment, the label 100 will be affixed only to one of the end caps 402, 404. In this contemplated embodiment, it is contemplated that the end cap 402, 404 that does not include the label 100 will include at least some identification information so that the first end cap 402 and the second end cap 404 correspond to one another, as would be appreciated by those skilled in the art.

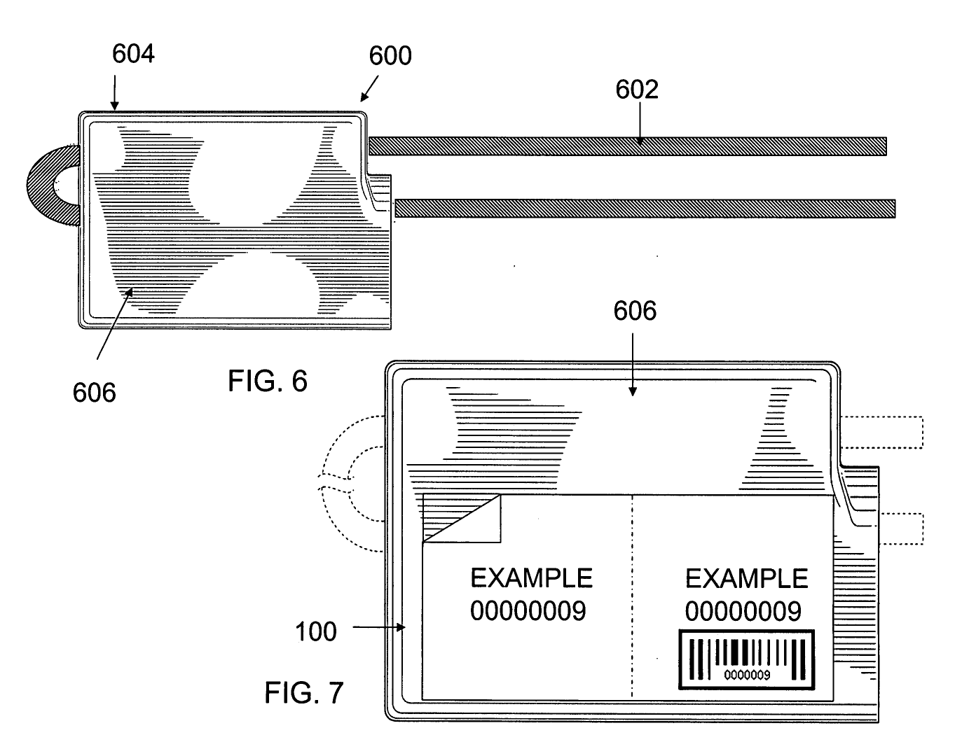

FIG. 6 illustrates an alternative security seal. In this illustration, a cable seal 600 is shown. To secure the opening into a freight car or tanker truck, for example, the cable seal 600 includes a cable 602. The cable 602 has a free end that is threaded through the locking structure(s) (not shown) on the doors of the freight container. The free end also is threaded though the body 604 of the cable seal 600. The body 604 of the cable seal 600 includes features therein to retain the cable 602 in a locked fashion once threaded through the body 604. The cable seal 600 has a surface 606 where the label 100 may be applied, as illustrated in FIG. 7.

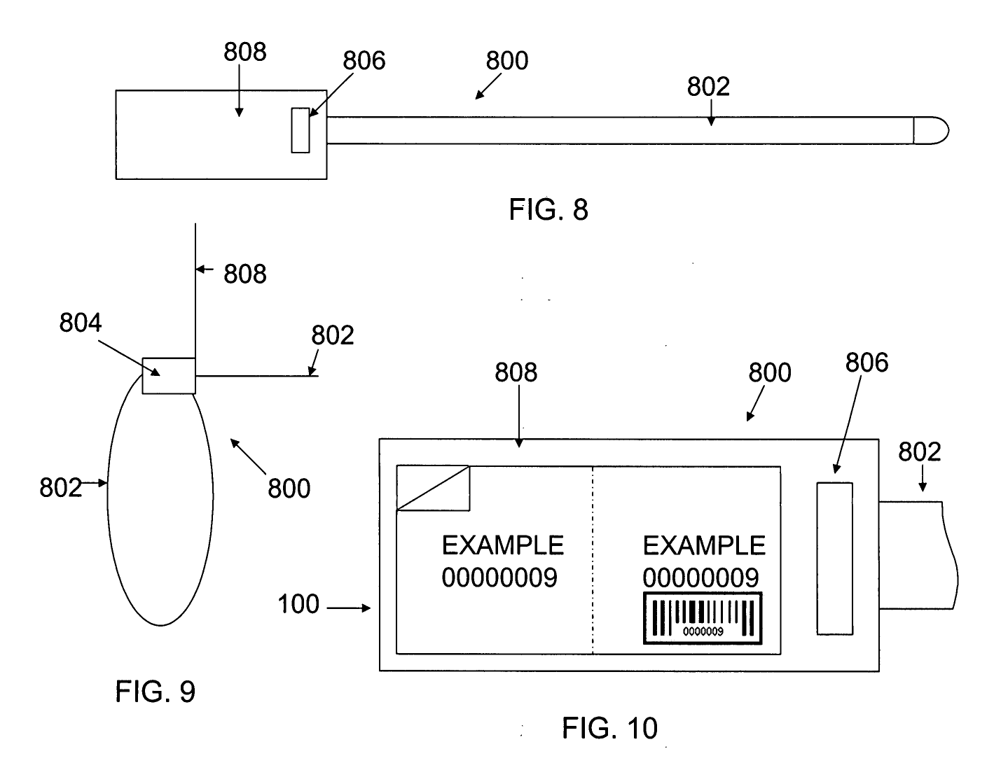

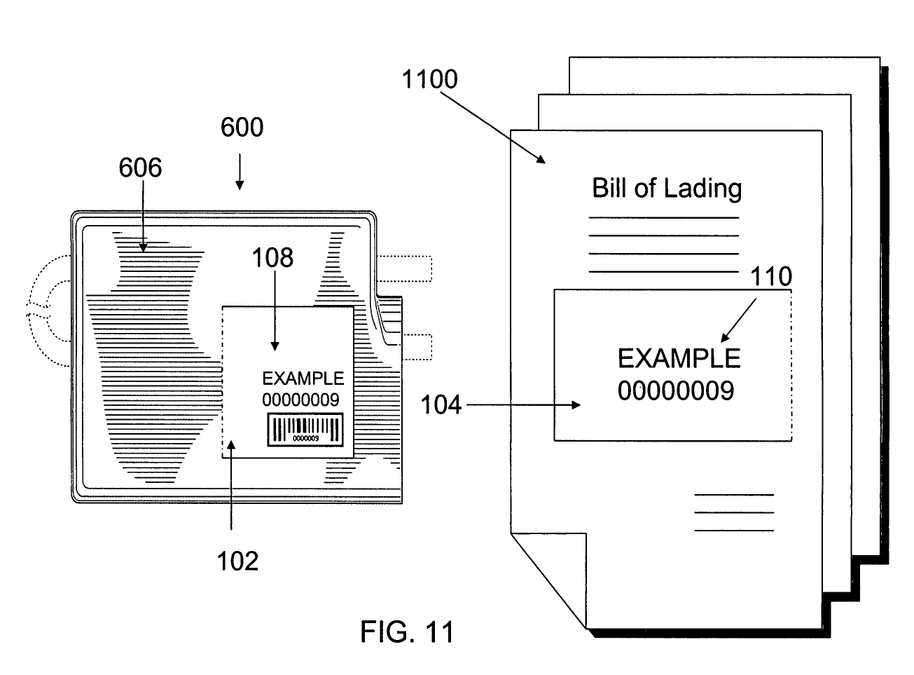

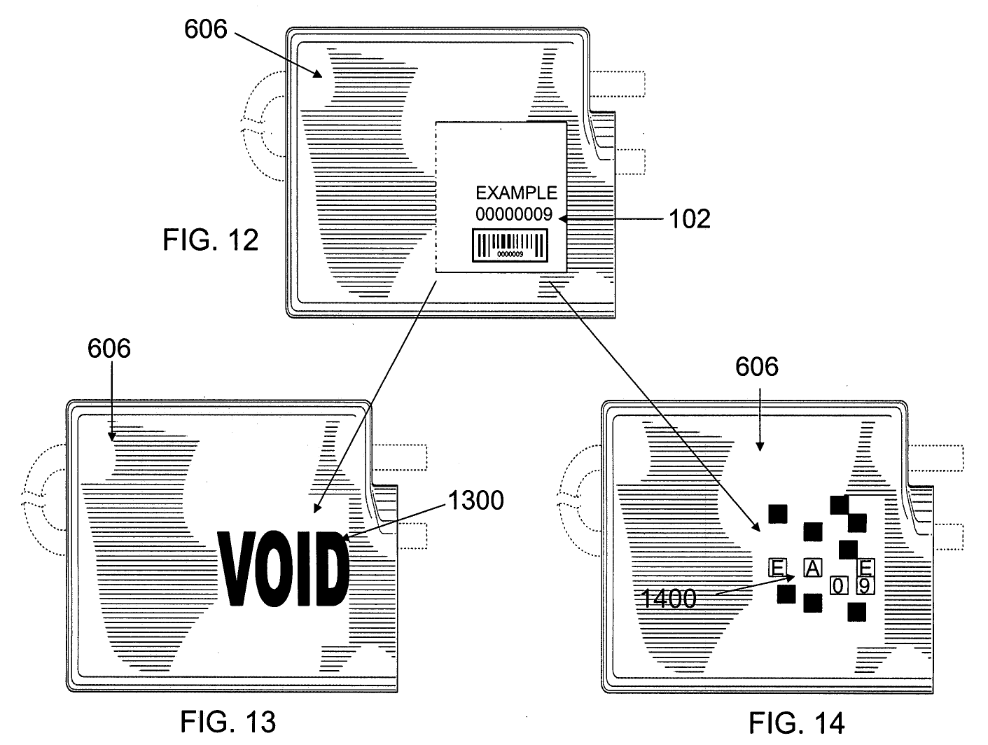

FIG. 8 illustrates a plastic security seal 800, otherwise referred to as a plastic seal 800. A side view of the plastic seal 800 is provided in FIG. 9. As shown, the plastic seal 800 includes a strap 802 that extends from and is inserted into a locking body 804, which is illustrated in FIG. 9. The strap 802 passes through a hole 806 in the locking body 804 to secure the strap 802 in the locking body 804. The locking body 804 is connected to a label platform 808, as shown. The label 100 is attached to the label platform 808 as illustrated in FIG. 10.

In accordance with at least one embodiment of the invention, the second portion 104 of the label may be attached to a document, such as a bill of lading 1100. The second portion 104 of the label 100 is affixed to the document 1100 to transfer the information 110 from the label 100 to the bill of lading 1100. The first portion 102 of the label 100 remains on the security seal 600 for further tracking information, as shown.

As mentioned above, the label 100 may include tamper-evident features 1300, 1400, which may be of any types permitting the identification of a removal or attempted removal of the label 100 from the surface of the seal 400, 600, 800. In accordance with at least one embodiment of the invention, when removal of the first portion 102 of the label 100 is attempted or accomplished, visible identification marks 1300 may remain indicating that the label has been tampered with. As illustrated in FIG. 13, the identification mark 1300 is the word “VOID.” The tamper evident feature also may include residue or a color-coded mark or stain on the surface 606.

In accordance with at least one embodiment of the invention, the tamper-evident property may be implemented by deterioration or fractioning of the first identification information 108 on the label 100, an example of which is shown in FIG. 14. As illustrated in FIG. 14, when the first portion 102 of the label 100 is removed or when removal is attempted, the label 100 disintegrates and leaves behind portions 1400 of the first identification information 108.

As would be appreciated by those skilled in the art, the tamper evident features 1300, 1400 that are illustrated in FIGS. 13 and 14 are but two examples and the present invention is not limited solely thereto.

Other variations of the invention also include a label with more than two portions 102, 104. The label could have multiple portions connected to each other or stacked upon each other. Multiple labels also could be positioned on the security seal 400, 600, 800 to transfer different information to different documents. The label could also be color coded to represent the material inside or represent which document the second portion 104 should be attached to.

While this invention has been described in conjunction with the specific embodiments outlined above, it is evident that many alternatives, modifications and variations will be apparent to those skilled in the art. Accordingly, embodiments of the invention, as set forth above, are intended to be illustrative, not limiting. Various changes may be made without departing from the spirit and scope of the invention.

What is claimed is:

1. A label, comprising:
a flexible body defining first and second portions connected to one another via a separable connection;
a first adhesive disposed on a rear surface of the first portion;
a second adhesive disposed on a rear surface of the second portion;
first information applied to a front surface of the first portion; and
second information applied to a front surface of the second portion,
wherein at least a portion of the first information is identical to a portion of the second information,
wherein at least one of either the first portion or the second portion comprises tamper-evident indicia such that attempted separation of either the first portion or the second portion from a substrate once affixed, exposes the tamper-evident indicia,
wherein the first adhesive is formulated to securely affix the first portion to a seal body, and
wherein the second adhesive is formulated to securely affix the second portion to a document.

2. The label of claim 1, wherein the separable connection is a perforation.

3. The label of claim 1, wherein the separable connection is a break point.

4. The label of claim 1, wherein the flexible body is a cellulose or paper material.

5. The label of claim 1, wherein the flexible body is an elastomeric or plastic material.

6. The label of claim 1, wherein the flexible body is a metal, alloy, or foil material.

7. The label of claim 1, wherein the information is laser printed.

8. The label of claim 1, wherein the first and second information is a barcode.

9. The label of claim 1, wherein the first and second information is a serial number.

10. The label of claim 1, wherein at least a portion of the first information is identical to the second information.

11. The label of claim 1, wherein the tamper evident indicia is a color, words, or frangible portion.

12. The label of claim 1, wherein the seal body is a cable seal, a bolt seal, or a plastic seal.

13. The label of claim 1, wherein the document is a bill of lading.

14. A security seal, comprising:
a body defining a surface for the application of a label;
a label comprising a flexible body defining first and second portions connected to one another via a separable connection;
a first adhesive disposed on a rear surface of the first portion;
a second adhesive disposed on a rear surface of the second portion;
first information applied to a front surface of the first portion; and
second information applied to a front surface of the second portion,
wherein at least a portion of the first information is identical to a portion of the second information,
wherein at least one of either the first portion or the second portion comprises tamper-evident indicia such that attempted separation of either the first portion or the second portion from a substrate once affixed, exposes the tamper-evident indicia,
wherein the first adhesive is formulated to securely affix the first portion to a seal body, and
wherein the second adhesive is formulated to securely affix the second portion to a document.

15. The security seal of claim 14, wherein the separable connection is a perforation.

16. The security seal of claim 14, wherein the separable connection is a break point.

17. The security seal of claim 14, wherein the flexible body is a cellulose or paper material.

18. The security seal of claim 14, wherein the flexible body is an elastomeric or plastic material.

19. The security seal of claim 14, wherein the flexible body is a metal, alloy, or foil material.

20. The security seal of claim 14, wherein the information is laser printed.

21. The security seal of claim 14, wherein the first and second information is a barcode.

22. The security seal of claim 14, wherein the first and second information is a serial number.

23. The security seal of claim 14, wherein at least a portion of the first information is identical to the second information.

24. The security seal of claim 14, wherein the tamper evident indicia is a color, words, or frangible portion.

25. The security seal of claim 14, wherein the seal body is a cable seal, a bolt seal, or a plastic seal.

26. The security seal of claim 14, wherein the document is a bill of lading.
